(19) United States
(12) Patent Application Publication
(10) Pub. No.: US 2025/0238858 A1
(43) Pub. Date: Jul. 24, 2025

(54) SYSTEMS AND METHODS FOR USING ARTIFICIAL INTELLIGENCE FOR REPORT GENERATION OF ELECTRONIC TRANSACTIONS

(71) Applicant: Fidelity Information Services, LLC, Jacksonville, FL (US)

(72) Inventors: Kieron PATERSON, Sydney (AU); Angad BAGGA, Mohali (IN); Gopal PADHI, Pune (IN); Julia DEMIDOVA, London (GB); Mayur SHIRADHONKAR, Pune (IN); Sudhanshu SHUKLA, Bengaluru (IN)

(21) Appl. No.: 18/758,330

(22) Filed: Jun. 28, 2024

(30) Foreign Application Priority Data
Jan. 23, 2024 (IN) 202411004607

(51) Int. Cl. G06Q 40/02

(52) U.S. Cl. CPC G06Q 40/02

(57) ABSTRACT

A method for report generation may include capturing a plurality of historical account data of a client account. The method may further include extracting a plurality of item level features from the plurality of historical account data. The method may further include providing the plurality of item level features and a set of user preferences to a natural language machine-learning model. The natural language machine-learning model may be trained to identify patterns within the plurality of item level features and generate one or more client account reports based on the identified patterns and the set of user preferences. The method may further include transmitting, to a user interface, the one or more client account reports.

### CROSS-REFERENCE TO RELATED APPLICATION(S)

This application claims the benefit or priority to Indian Application No. 202411004607, filed on Jan. 23, 2024, the entirety of which is incorporated herein by reference.

### TECHNICAL FIELD

Various embodiments of this disclosure relate generally to artificial intelligence and machine-learning-based techniques for managing electronic transactions and accounts.

### BACKGROUND

Administrators of computing systems may face challenges in analyzing and taking actions based on data related to such computing systems. In some cases, administrators may risk exposure because of an inability to timely analyze and act upon data in real-time.

Unless otherwise indicated herein, the materials described in this section are not prior art to the claims in this application and are not admitted to be prior art, or suggestions of the prior art, by inclusion in this section.

### SUMMARY OF THE DISCLOSURE

In one aspect, an exemplary embodiment of a method for report generation may include capturing a plurality of historical account data of a client account. The method may further include extracting a plurality of item level features from the plurality of historical account data. The method may further include providing the plurality of item level features and a set of user preferences to a natural language machine-learning model. The natural language machine-learning model may be trained to identify patterns within the plurality of item level features and generate one or more client account reports based on the identified patterns and the set of user preferences. The method may further include transmitting, to a user interface, the one or more client account reports.

In another aspect, an exemplary embodiment of a system for report generation may include a memory storing instructions and a natural language machine-learning model. The natural language machine-learning model may be trained to identify patterns within the plurality of item level features and generate one or more client account reports based on the identified patterns and the set of user preferences. The system may further include a processor operatively connected to the memory and configured to execute the instructions to perform operations. The operations may include capturing a plurality of historical account data of a client account. The operations may further include extracting the plurality of item level features from the plurality of historical account data. The operations may further include providing the plurality of item level features and the set of user preferences to the natural language machine-learning model. The operations may further include transmitting, to a user interface, the one or more client account reports.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 depicts an exemplary environment for using a machine-learning model for rules-based modeling, according to one or more embodiments.

FIG. 2 depicts a flowchart of an exemplary method for rules-based modeling, according to one or more embodiments.

FIG. 3 depicts a flowchart of an exemplary method for liquidity optimization, according to one or more embodiments.

FIG. 4 depicts a flowchart of an exemplary method for report generation, according to one or more embodiments.

FIG. 5 depicts a flow diagram for training a machine-learning model, according to one or more embodiments.

FIG. 6 depicts an example of a computing device, according to one or more embodiments.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION

Various aspects of the present disclosure relate generally to artificial intelligence and machine-learning-based techniques for managing electronic transactions and accounts, and more particularly to decision-making using artificial intelligence and other machine-learning models. A simple and seamless path to better visibility into cash and risk may therefore be possible. Artificial intelligence models may be used for managing accounts, such as extracting data, generating queries, forecasting account balances, predicting and executing best practices for liquidity, generating reports using natural language processing, and the like. An artificial intelligence model, or machine-learning model, may generate scenarios for liquidity optimization based on a set of rules, and automatically select the best scenario. Further, sentiment analysis and forecasting may be used to predict closing balances, cash flows, and the like.

Using the disclosed techniques, users (e.g., account owners, administrators, or managers) may optimize returns, minimize costs, and mitigate risks associated with both present and future cash positions. Users may effectively manage cash resources whether those resources are meant for short-term or long-term liquidity. The decision-making process, and the execution of these decisions, to achieve these results may be automated by using the techniques described herein.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine-learning and artificial intelligence, it should be understood that techniques according to this disclosure may be adapted to any suitable type of machine-learning and artificial intelligence. It should also be understood that the examples above are illustrative only. The techniques and technologies of this disclosure may be adapted to any suitable activity.

While financial applications and various aspects relating to finance (e.g., account management and automation) are described in the present aspects as illustrative examples, the present aspects are not limited to such examples. For example, the present aspects can be implemented for other types of fields, such as in any scenario related to optimizing data, predicting outcomes, or generating reports.

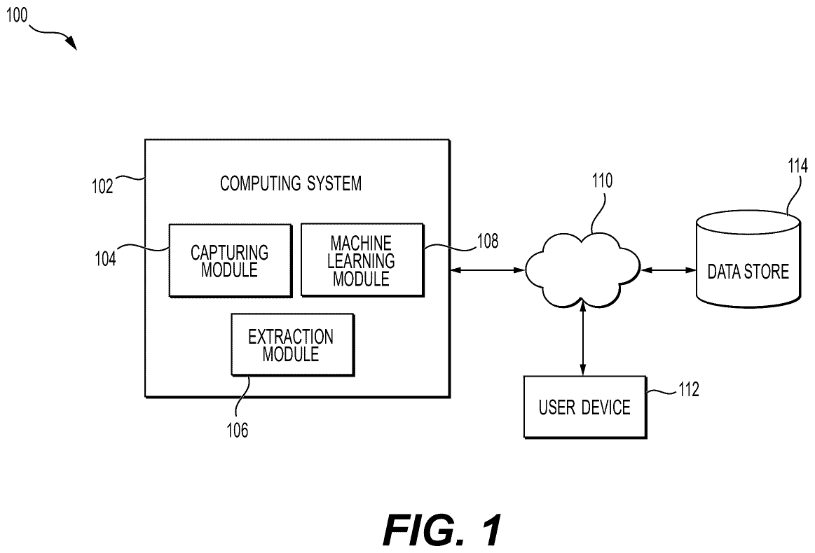

FIG. 1 depicts an exemplary environment 100 that may be utilized with techniques presented herein. One or more user device(s) 112 may communicate across an electronic network 110. The one or more user device(s) 112 may be associated with a user, e.g., a user that is managing an account, an administrator of one or more components of environment 100, or the like. As will be discussed in further detail below, one or more computing system(s) 102 may communicate with one or more of the other components of the environment 100 across electronic network 110.

The user device(s) 112 may be configured to enable a user to access and/or interact with other systems in the environment 100. For example, the user device(s) 112 may each be a computer system such as, for example, a desktop computer, a mobile device, a tablet, etc. In some embodiments, the user device(s) 112 may include one or more electronic application(s), e.g., a program, plugin, browser extension, etc., installed on a memory of the user device(s) 112. In some embodiments, the electronic application(s) may be associated with one or more of the other components in the environment 100. For example, the electronic application(s) may include one or more of system control software, system monitoring software, software development tools, etc.

In various embodiments, the environment 100 may include a data store 114 (e.g., database). The data store 114 may include a server system and/or a data storage system such as computer-readable memory such as a hard drive, flash drive, disk, etc. In some embodiments, the data store 114 includes and/or interacts with an application programming interface for exchanging data to other systems, e.g., one or more of the other components of the environment. The data store 114 may include and/or act as a repository or source for storing historical transaction data, item level features, input and/or output of the machine-learning or artificial intelligence models, generated reports, and the like (e.g., a user of user device 112 or any of the other components of environment 100).

In some embodiments, the components of the environment 100 are associated with a common entity, e.g., a corporate or financial institution, a service provider, an account provider, or the like. For example, in some embodiments, computing system 102 and data store 114 may be associated with a common entity. In some embodiments, one or more of the components of the environment is associated with a different entity than another. For example, computing system 102 may be associated with a first entity (e.g., a service provider) while data store 114 may be associated with a second entity (e.g., a storage entity providing storage services to the first entity). The systems and devices of the environment 100 may communicate in any arrangement. As will be discussed herein, systems and/or devices of the environment 100 may communicate in order to one or more of generate, train, or use a machine-learning and/or artificial intelligence model to manage accounts, among other activities.

As discussed in further detail below, the computing system(s) 102 may one or more of (i) generate, store, train, or use a machine-learning model configured to manage an account. The computing system(s) 102 may include a machine-learning model and/or instructions associated with the machine-learning model, e.g., instructions for generating a machine-learning model, training the machine-learning model, using the machine-learning model etc. The computing system(s) 102 may include instructions for retrieving data, adjusting data, e.g., based on the output of the machine-learning model, and/or operating a display of the user device(s) 112 to output the results, e.g., as adjusted based on the machine-learning model. The computing system(s) 102 may include training data, e.g., historical transaction data and/or item level features, and may include ground truth, e.g., (i) training historical transaction data and (ii) training item level feature data to generate the output.

As depicted in FIG. 1, computing system(s) 102 may include capturing module 104. In various embodiments, capturing module 104 is configured to capture historical transaction data of a client account. The historical transaction data may be received by computing system(s) 102 over network 110.

Computing system(s) 102 may also include extraction module 106. In various embodiments, extraction module 106 may be configured to extract item level features from the historical transaction data. The item level features may be stored in data store 114 and retrieved by components of computing system 102 for use.

As depicted in FIG. 1, computing system(s) 102 may also include machine-learning module 108. In some embodiments, a system or device other than the computing system(s) 102 is used to generate and/or train the machine-learning model. For example, such a system may include instructions for generating the machine-learning model, the training data and ground truth, and/or instructions for training the machine-learning model. A resulting trained-machine-learning model may then be provided to the computing system(s) 102.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations and/or identify patterns in item level features and/or historical transaction data such that the trained machine-learning model is configured to generate output results.

In various embodiments, the variables of a machine-learning model may be interrelated in any suitable arrangement in order to generate the output. For example, in some embodiments, the machine-learning model may include data processing architecture that is configured to identify, isolate, and/or extract features in one or more of historical transaction data and item level features. For example, the machine-learning model may include one or more convolutional neural network (“CNN”) configured to identify patterns in the item level features, and may include further architecture, e.g., a connected layer, neural network, etc., configured to determine a relationship between the identified patterns in order to output a prediction, action to be taken, or to generate a report.

In some embodiments, the machine-learning model of the computing system 102 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of item level features and output a prediction, action to be taken, a projected balance, a report, or the like.

As depicted in FIG. 1, environment 100 may also include electronic network 110. In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Although depicted as separate components in FIG. 1, it should be understood that a component or portion of a component in the environment 100 may, in some embodiments, be integrated with or incorporated into one or more other components. In another example, the computing system 102 may be integrated in a data storage system. The data storage system may be configured to communicate and/or receive/send data across electronic network 110 to other components of environment 100. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to process historical account data and/or item level features are discussed in further detail in the methods below. In the following methods, various acts may be described as performed or executed by a component from FIG. 1, such as the computing system 102, the user device 112, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

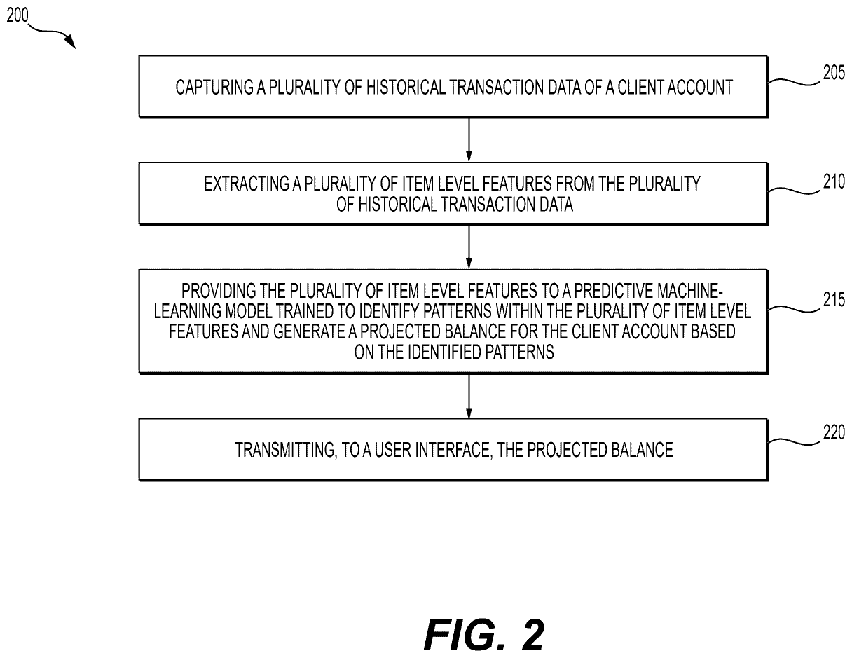

FIG. 2 illustrates an exemplary method 200 for rules-based modeling. Exemplary method 200 begins with step 205, wherein a plurality of historical transaction data of a client account is captured. In examples, the plurality of historical transaction data may include funds transfers, purchases, account credits, payments, or the like. The historical transaction data may represent any feasible period of time, such as days, weeks, or years. The period of time from which historical transaction data is captured may be the life of the account, though a computing system (e.g., such as computing system 102 depicted in FIG. 1) may capture a portion of the historical transaction data over the life of the account for processing. For example, if the account has been open for 2 years, the computing system may capture historical transaction data from the last 3 months as a subset of the total historical transaction data captured, for processing. At step 210, a plurality of item level features are extracted from the plurality of historical transaction data. In examples, the plurality of item level features may include numerical and/or textual data associated with the historical transaction data. Such numerical and/or textual data may represent monetary amounts, identifiers associated with the accounts associated with each transaction, and the like. In various embodiments, the item level features are data that may be processed as extracted from the historical transaction data that provide the history of the client account.

At step 215, the plurality of item level features are provided to a predictive machine-learning model. The predictive machine-learning model may be trained to identify patterns within the plurality of item level features and to generate a projected balance for the client account based on the identified patterns. In examples, the predictive machine-learning model may identify patterns such as decreases in the account balance after a series of historical actions taken on the account. In this way, it may be predicted that if similar actions are taken on the account, the account balance may decrease in a similar way. In other examples, the predictive machine-learning model may identify patterns associated with correlated events. In a particular example, an account balance may have historically seen an increase with each change to the interest rate. Therefore, the predictive machine-learning model may be trained to identify those patterns in factors that affect the client account, thereby allowing the predictive machine-learning model to output a projected balance for the client account, given a current or simulated set of circumstances. Exemplary method 200 concludes at step 220, wherein the projected balance may be transmitted to a user interface (e.g., of user device 112 as depicted in FIG. 1).

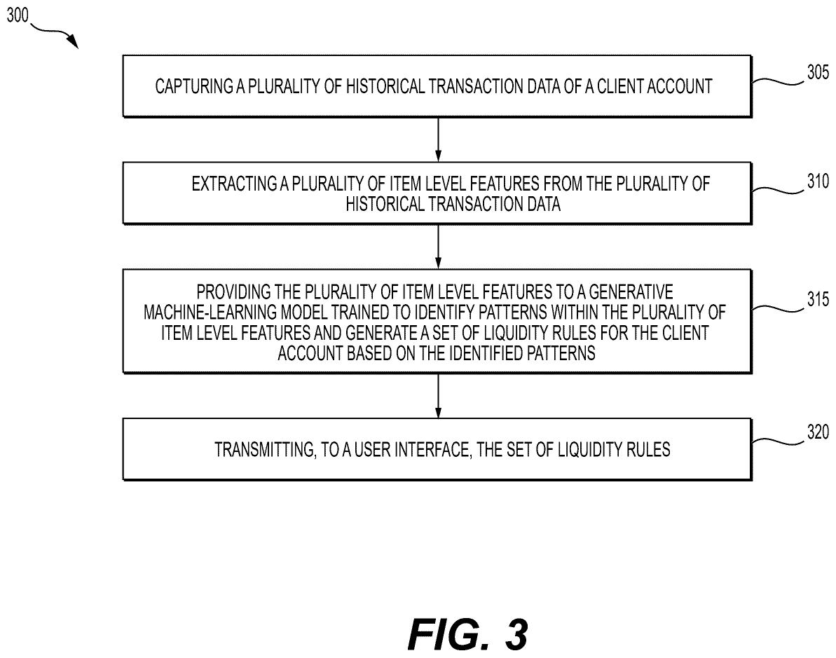

FIG. 3 illustrates an exemplary method 300 for liquidity optimization. Exemplary method 300 begins with step 305, wherein a plurality of historical transaction data of a client account is captured. In examples, the plurality of historical transaction data may include funds transfers, purchases, account credits, payments, or the like. As described with respect to FIG. 2 above, the historical transaction data may represent a record of actions taken with respect to the client account and may be captured relative to the relevancy of the data for processing (e.g., from a certain period of time). At step 310, a plurality of item level features is extracted from the plurality of historical transaction data. In examples, the plurality of item level features may include numerical and/or textual data associated with the historical transaction data. In examples, extracting the item level features from the historical transaction data may allow for ease of processing by a computing system (e.g., such as computing system 102, as depicted in FIG. 1) or by a machine-learning model, such as those described herein.

At step 315, the plurality of item level features are provided to a generative machine-learning model. The generative machine-learning model may be trained to identify patterns within the plurality of item level features and to generate a set of liquidity rules for the client account based on the identified patterns. In various embodiments, the set of liquidity rules may take the form of computer instructions or operations to cause actions to be taken on the client account. In other examples, the set of liquidity rules may be output by the machine-learning model and may then be formatted by the computing system, such as with an artificial intelligence model, into natural language that may be understood by a user as a set of steps or actions to be taken.

Therefore, in examples, the set of liquidity rules may be applied to the client account. As described above, the set of liquidity rules may be applied automatically to the client account via the computing system. In such examples, optimized transaction actions may be executed on the client account based on the set of liquidity rules. In various embodiments, the optimized transaction actions may be provided to a predictive machine-learning model (e.g., such as that described with respect to FIG. 2 above). The predictive machine-learning model may be further trained to identify patterns within the optimized transaction actions and to generate a predicted balance for the client account based on the identified patterns. In such examples, the predictive machine-learning model may predict an account balance of the client account based on the simulated execution of the optimized transaction actions upon the client account. Exemplary method 300 concludes at step 320, wherein the set of liquidity rules may be transmitted to a user interface (e.g., of user device 112 as depicted in FIG. 1). In examples, the predicted balance may also be transmitted to the user interface.

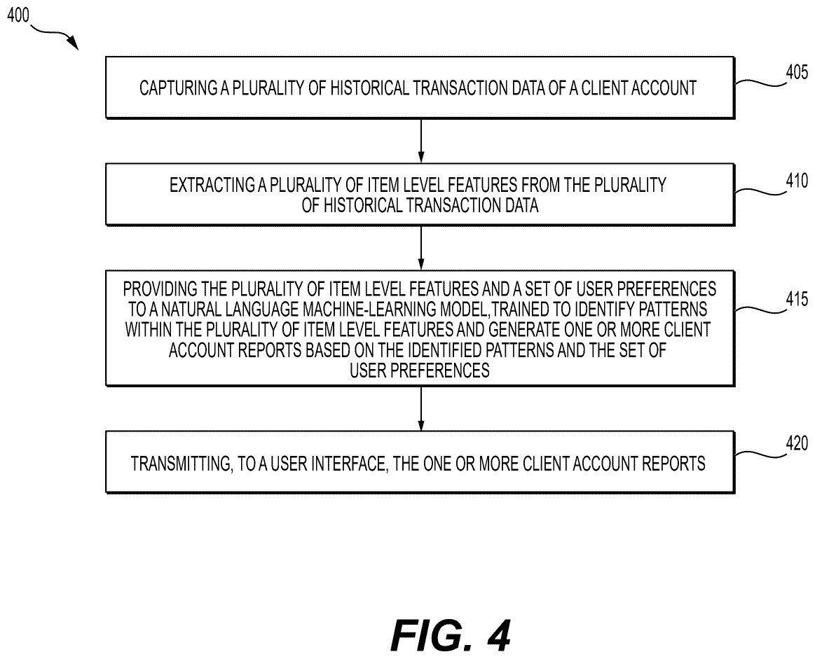

FIG. 4 illustrates an exemplary method 400 for report generation. Exemplary method 400 begins with step 405, wherein a plurality of historical transaction data of a client account is captured, such as in any of the methods described herein. In examples, the plurality of historical transaction data may include funds transfers, purchases, account credits, payments, or the like. At step 410, a plurality of item level features is extracted from the plurality of historical transaction data. In examples, the plurality of item level features may include numerical and/or textual data associated with the historical transaction data. At step 415, the plurality of item level features and a set of user preferences is provided to a natural language machine-learning model. In examples, the set of user preferences may include parameters for the ultimately generated client account report. In particular examples, such parameters may include selecting a certain period of time to be the subject of the report, selecting particular transaction types to be reflected in the report, or the like.

The natural language machine-learning model may be trained to identify patterns within the plurality of item level features and to generate one or more client account reports based on the identified patterns and the set of user preferences. In examples, the natural language machine-learning model may be an artificial intelligence model. In various embodiments, the natural language machine-learning model may utilize a natural language processor, or an artificial intelligence model, to generate the client account report using language that a user would understand, essentially describing the identified patterns in natural language. In examples, the client account report may describe for a user what took place with the client account and why certain circumstances or factors affected the client account and in what ways. Exemplary method 400 concludes at step 420, wherein the one or more client account reports may be transmitted to a user interface (e.g., of user device 112 as depicted in FIG. 1).

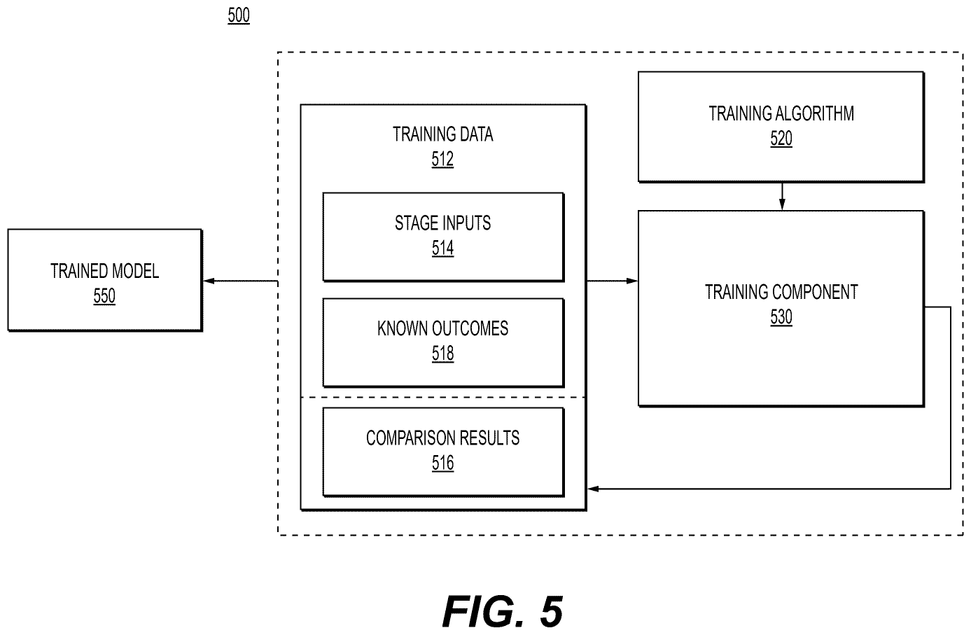

FIG. 5 depicts a flow diagram for training a machine-learning model. As shown in flow diagram 500 of FIG. 5, training data 512 may include one or more of stage inputs 514 and known outcomes 518 related to a machine-learning model to be trained. The stage inputs 514 may be from any applicable source including a component or set shown in the figures provided herein. The known outcomes 518 may be included for machine-learning models generated based on supervised or semi-supervised training. An unsupervised machine-learning model might not be trained using known outcomes 518. Known outcomes 518 may include known or desired outputs for future inputs similar to or in the same category as stage inputs 514 that do not have corresponding known outputs.

The training data 512 and a training algorithm 520 may be provided to a training component 530 that may apply the training data 512 to the training algorithm 520 to generate a trained machine-learning model 550. According to an implementation, the training component 530 may be provided comparison results 516 that compare a previous output of the corresponding machine-learning model to apply the previous result to re-train the machine-learning model. The comparison results 516 may be used by the training component 530 to update the corresponding machine-learning model. The training algorithm 520 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flowchart 500 may be a trained machine-learning model 550.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

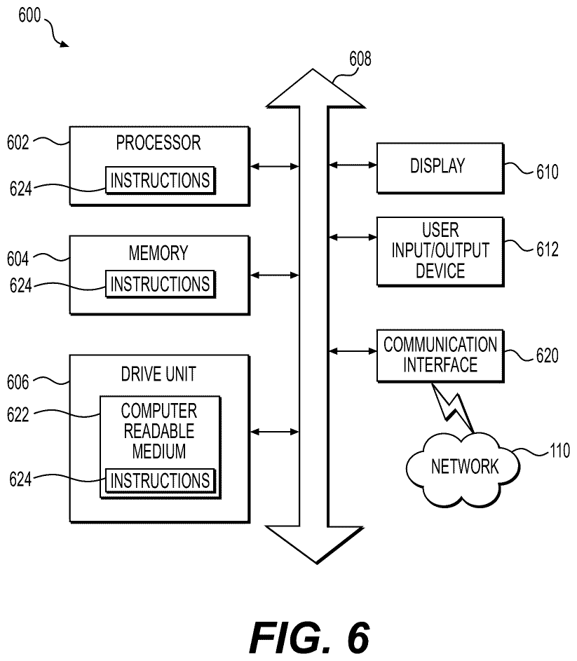

FIG. 6 is a simplified functional block diagram of a computer 600 that may be configured as a device for executing the methods disclosed here, according to exemplary aspects of the present disclosure. For example, the computer 600 may be configured as a system according to exemplary aspects of this disclosure. In various aspects, any of the systems herein may be a computer 600 including, for example, a data communication interface 620 for packet data communication. The computer 600 also may include a central processing unit (“CPU”) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications.

The computer 600 may also have a memory 604 (such as RAM) storing instructions 624 for executing techniques presented herein, for example the methods described with respect to FIGS. 2-4, although the instructions 624 may be stored temporarily or permanently within other modules of computer 600 (e.g., processor 602 and/or computer readable medium 622). The computer 600 also may include input and output ports 612 and/or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for report generation, the method comprising:
capturing, by one or more processors, a plurality of historical account data of a client account;
extracting, by the one or more processors, a plurality of item level features from the plurality of historical account data;
providing, by the one or more processors, the plurality of item level features and a set of user preferences to a natural language machine-learning model, trained to identify patterns within the plurality of item level features and generate one or more client account reports based on the identified patterns and the set of user preferences; and
transmitting, to a user interface by the one or more processors, the one or more client account reports.

2. The computer-implemented method of claim 1, wherein the natural language machine-learning model is an artificial intelligence model.

3. The computer-implemented method of claim 1, further comprising:
providing, by the one or more processors, the plurality of item level features to a predictive machine-learning model trained to identify patterns within the plurality of item level features and generate a projected balance for the client account based on the identified patterns; and
transmitting, to the user interface by the one or more processors, the projected balance.

4. The computer-implemented method of claim 1, further comprising:
providing, by the one or more processors, the plurality of item level features to a generative machine-learning model trained to identify patterns within the plurality of item level features and generate a set of liquidity rules for the client account based on the identified patterns; and
transmitting, to the user interface by the one or more processors, the set of liquidity rules.

5. The computer-implemented method of claim 4, further comprising:
applying, by the one or more processors, the set of liquidity rules to the client account; and
executing, by the one or more processors and on the client account, optimized transaction actions based on the set of liquidity rules.

6. The computer-implemented method of claim 5, further comprising:
providing, by the one or more processors, the optimized transaction actions to a predictive machine-learning model trained to identify patterns within the optimized transaction actions and generate a predicted balance for the client account based on the identified patterns; and
transmitting, to the user interface by the one or more processors, the predicted balance.

7. A system for report generation, the system comprising:
a memory storing instructions and a natural language machine-learning model, trained to identify patterns within a plurality of item level features and generate one or more client account reports based on the identified patterns and a set of user preferences; and
a processor operatively connected to the memory and configured to execute the instructions to perform operations including:
capturing, by the processor, a plurality of historical account data of a client account;
extracting, by the processor, the plurality of item level features from the plurality of historical account data;
providing, by the processor, the plurality of item level features and the set of user preferences to the natural language machine-learning model; and
transmitting, to a user interface by the processor, the one or more client account reports.

8. The system of claim 7, wherein the natural language machine-learning model is an artificial intelligence model.

9. The system of claim 7, further comprising:
providing, by the processor, the plurality of item level features to a predictive machine-learning model trained to identify patterns within the plurality of item level features and generate a projected balance for the client account based on the identified patterns; and
transmitting, to the user interface by the processor, the projected balance.

10. The system of claim 7, further comprising:
providing, by the processor, the plurality of item level features to a generative machine-learning model trained to identify patterns within the plurality of item level features and generate a set of liquidity rules for the client account based on the identified patterns; and
transmitting, to the user interface by the processor, the set of liquidity rules.

11. The system of claim 10, further comprising:
applying, by the processor, the set of liquidity rules to the client account; and
executing, by the processor and on the client account, optimized transaction actions based on the set of liquidity rules.

12. The system of claim 11, further comprising:
providing, by the processor, the optimized transaction actions to a predictive machine-learning model trained to identify patterns within the optimized transaction actions and generate a predicted balance for the client account based on the identified patterns; and
transmitting, to the user interface by the processor, the predicted balance.

13. A non-transitory computer-readable medium storing instructions that, when executed by one or more processors, perform operations including:
capturing, by one or more processors, a plurality of historical account data of a client account;
extracting, by the one or more processors, a plurality of item level features from the plurality of historical account data;
providing, by the one or more processors, the plurality of item level features and a set of user preferences to a natural language machine-learning model, trained to identify patterns within the plurality of item level features and generate one or more client account reports based on the identified patterns and the set of user preferences; and
transmitting, to a user interface by the one or more processors, the one or more client account reports.

14. The non-transitory computer-readable medium of claim 13, wherein the natural language machine-learning model is an artificial intelligence model.

15. The non-transitory computer-readable medium of claim 13, the operations further comprising:
providing, by the one or more processors, the plurality of item level features to a predictive machine-learning model trained to identify patterns within the plurality of item level features and generate a projected balance for the client account based on the identified patterns; and
transmitting, to the user interface by the one or more processors, the projected balance.

16. The non-transitory computer-readable medium of claim 13, the operations further comprising:
providing, by the one or more processors, the plurality of item level features to a generative machine-learning model trained to identify patterns within the plurality of item level features and generate a set of liquidity rules for the client account based on the identified patterns; and
transmitting, to the user interface by the one or more processors, the set of liquidity rules.

17. The non-transitory computer-readable medium of claim 16, the operations further comprising:
applying, by the one or more processors, the set of liquidity rules to the client account; and
executing, by the one or more processors and on the client account, optimized transaction actions based on the set of liquidity rules.

18. The non-transitory computer-readable medium of claim 17, the operations further comprising:
providing, by the one or more processors, the optimized transaction actions to a predictive machine-learning model trained to identify patterns within the optimized transaction actions and generate a predicted balance for the client account based on the identified patterns; and
transmitting, to the user interface by the one or more processors, the predicted balance.

19. The non-transitory computer-readable medium of claim 13, wherein the plurality of historical account data comprises at least one of a funds transfer, a purchase, an account credit, or a payment.

20. The non-transitory computer-readable medium of claim 13, wherein the plurality of item level features comprise numerical and/or textual data associated with the plurality of historical account data.
